(19) United States
(12) Patent Application Publication
(10) Pub. No.: US 2013/0103437 A1
(43) Pub. Date: Apr. 25, 2013

(54) DIGITAL METHOD FOR PROVIDING TRANSPORTATION SERVICES RELATED APPLICATIONS

(71) Applicant: Mark J. Nelson, Boca Raton, FL (US)

(72) Inventor: Mark J. Nelson, Boca Raton, FL (US)

(21) Appl. No.: 13/278,253

(22) Filed: Oct. 21, 2011

(51) Int. Cl. G06Q 10/02

(52) U.S. Cl. 705/6

(57) ABSTRACT

A method for providing airline patrons with a car service reservation system which facilitates car services and an efficient pricing system for customers on a flat fee, non-metered basis. The ground transportation service provider system allows patrons to rate the transportation service they receive upon arrival to final destination.

### BACKGROUND OF THE INVENTION

1. Field of the Invention

This invention is directed to providing transportation services for potential customers while booking other travel reservations, i.e., airline, train, cruise ship, etc., and more particularly to a method for assisting customers with an instant digital transportation reservation system.

2. Background of the Invention

A system for providing a transportation reservation service is known in the prior art. More specifically, by way of example, U.S. PreGrant Publication No. 2006/0059023 A1 to Mashinsky discloses a system and method for providing taxi patrons with a taxi-reservation system (metered transportation services) which facilitates better taxi service, better time utilization and financial rewards for taxi drivers who provide better service, and more efficient pricing for buyers. The taxi-reservation system allows patrons to rate the taxi service they receive as well as pre-select taxi drivers from a pool of available taxi drivers. The system further enables taxi drivers to participate in a pricing scheme where customers can bid on proposed fares for their trips, and drivers, dispatchers or companies can bid on customers.

The contents of various portions of the system for providing taxi patrons with a taxi-reservation system which facilitates taxi service, time utilization and financial rewards for taxi drivers who provide better service, and more efficient pricing for buyers which is disclosed in prior art US PreGrant Publication No. 200610059023 A1, are incorporated herein in whole or in part to provide a more complete and better understanding of this invention.

The purpose of this invention is to allow airline, train, cruise ship, etc., reservation customers the ability to reserve transportation services on the same website. This method is to provide customers the ability to reserve ground transportation services (non-metered transportation services) via the internee utilizing various airline and intermediate websites. By incorporating this invention each company will alter their GUI (graphical user interface) so it will support this invention. As it is difficult for private transportation service providers “transportation service provider” to pick-up potential customers without going through a protracted reservation process, transportation service provider works through a digital form of communication, i.e., e-mail and SMS (aka text messaging) that receives requests from customers for scheduled transportation. These services then communicate with local transportation service providers of the customer's departure and arrival points. Transportation service providers are contacted via e-mail while the customer is booking a flight and/or hotel reservations utilizing GUI which is provided to the aforementioned airline and intermediately travel associates. Customer bookings can not reserve transportation no later than 24 hours before required service. No metered transportation service providers are allowed or permitted to subscribe to this service and there will be no bidding for potential clients.

### SUMMARY OF THE INVENTION

The purpose of this invention is to provide transportation service provider patrons with a digital vehicle service reservation system which allows better ground transportation service, better time utilization for transportation service provider's who provide better service and more efficient pricing for customers.

The service disclosed solves various problems associated with the identification, reservation, procurement, dispatch, pricing, rating and payment for car services by customers.

This invention involves a new method of digital communication operated by a user, involving the following sequence: accessing a transportation reservation system via an internet-enabled device for airline, train, cruise ship via America Airlines, Delta, United, etc. websites; the transportation reservation system being in communication with a plurality of independent travel service providers via e-mail; instant pricing can be transmitted to the potential customer from the database; receiving transportation service information from the transportation reservation system by e-mailing transportation service providers in the areas that the customer will be traveling in response to the travel service request; this may involve e-mailing multiple transportation service providers in multiple cities; transmitting pricing and a travel service request confirmation to the customer; and receiving transportation service in accordance with the confirmation e-mail; at completion of travel, the system will e-mail the customer a survey for rating the level of service received by the transportation service provider(s).

The invention involves a method of providing transportation services by a digital reservation service provider, including: receiving e-mail notification from a plurality of independent transportation service provider(s) regarding availability for providing transportation; receiving a reservation request from a customer; transmitting the reservation request to a transportation service provider; receiving confirmation from the transportation service provider regarding providing transportation service(s).

In an exemplary embodiment of the present invention, there is disclosed a computer implemented method for digitally receiving assistance with transportation reservations, comprises:

a. accessing a transportation reservation system via an Internet-enabled device, said transportation reservation system being in digital e-mail communication with a plurality of independent travel service providers;

b. digitally transmitting a travel service request to the transportation reservation system;

c. receiving transportation service information digitally from the transportation reservation system in response to the travel service request;

d. transmitting a digital travel request confirmation to the transportation reservation system; and

e. receiving transportation service in accordance with a digital confirmation.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carded out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIGS. 1A and 1B is a copy of a transportation service provider sign up form;

FIG. 2 is a flow diagram of a user direct sign up form;

FIG. 3 is a diagram of a user second party air sign up process where the second party is Virgin Air;

FIG. 4 is a diagram of a user second party cruise ship sign up process where the second party is Royal;

FIG. 5 is a diagram of a user second party train company sign up process where the second party is AMTrack;

FIG. 6 is a diagram of a user third party sign up process where the third party is EXPEDIA;

FIG. 7 is a flow diagram of a completion of travel survey form; and

FIG. 8 is a flow diagram of a method for a transportation service provider reservation system which provides transportation service provider patrons access to a system where patrons can rate the service they receive. As a result, patrons can enjoy better services

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated devices, and such further applications of the principles of the invention as illustrated therein being contemplated as would normally occur to one skilled in the art to which the invention relates.

The digital transportation service provider reservation system provides transportation service provider patrons access to a system which allows patrons to rate the service they receive. As a result, patrons can enjoy better services.

The transportation service provider reservation system comprises an application with two user interfaces: a transportation provider interface and a customer interface which may be located on various websites, i.e., American Airlines, Delta, United with a ever changing GUI (graphical user interface). The transportation service provider is accessible by registered transportation service providers and dispatchers who sign up for our service. The software allows management of car inventory and availability, allowing transportation service provider dispatchers to select arriving and departing passengers in a non-bid format. The system will interface with limo companies so all such functions can be performed automatically based on real time matching to optimize fleet utilization. The customer interface is accessible by any airline user or wholesale reservation network equipped with the interface protocol which is accessible via computer, smart phone, or any wireless internet access device (such as a Palm VII, Blackberry, WAP phone, and the like), which allows potential customers to schedule, view pricing and book available transportation services and to rate driver service. The application server may reside anywhere on the Internet, and comprises commercial Relational Database Management Systems (RDBMS), middleware and presentation software with our custom programming.

This system allows customers to locate the right company based on vehicle location and price. Such ranking can be based on many parameters including price, location, length of time required, pickup and delivery flexibility, car type and other parameters decided by our company.

This system allows via SMS (aka text messaging) notified drivers of changes in flight, train, and ship arrival and departure information where necessary so that rescheduling can be made immediately upon such information becoming available, as opposed to the common practice of having car drivers sit and wait just to be notified of the delays or cancellation.

The transportation service provider reservation system provides origin and destination data which is submitted by the user, This information is then used by the transportation companies for a reservation. The system also automatically provides pricing information based on time of day so supply & demand considerations, historical pricing data and special charges may be included as well as all anticipated tolls and gratuity charges. As a result, this system allows matching of the exact type of vehicle to the exact requirement of the passenger, as well as number of passengers.

As a result, customers and transportation service providers can use a central system to conduct all of their transactions in an automated dispatch. In one embodiment, payment is made at time of reservation so drivers don't have to carry cash or expensive credit card authorization equipment. By digitizing car availability and scheduling from several transportation service providers a much higher availability, utilization and matching of supply and demand is possible. This results in higher revenues for the car companies while providing lower fares to the passengers. Transportation service providers simply select their, jobs and then check in electronically to the system each day to confirm their acceptance of the daily trips and go ahead to drive their cars.

Furthermore, the data of the system may be linked to the airline, train, ship, hotel, tourist reservation systems and other reservation networks. As a result, a complete online trip planning identification, scheduling, and payment workflow can be enabled. By the use of digital information, the system confirms that a driver is on their way to pick up a specific passenger, and if the driver is not available or has, for example, a problem with their car, the system immediately reassigns another pending driver with an assignment to perform he job and reconciles the payment data as well as the notification to passenger.

Access to such a digital reservation system can be initiated using other reservation networks, a web browser, wireless devices or telephones, in which case the calls are placed to a central call center. The system may utilize outside networks to provide other relevant information such as flight times, weather or scheduled arrival and departure of transportation system.

The database collects and records information related to the users who access the system, including their e-mail addresses, as well as rating and satisfaction information so that it can be rated for internal purposes only. Such information is added to the actual performance of drivers which include; on time arrival, and other relevant parameters.

By providing transportation companies with free on line software that they can use to manage their reservation and scheduling, the central server has access in real-time to the status of both independent car drivers as well as the inventory and availability of car service companies. The system is designed to accommodate reservations for less than 50 passengers per pick up/drop off.

As a result of this setup, the job of the database is changed to deal with exceptions and the maximization of revenues for its transportation service providers, because all the reservation flow is digital and done automatically by the system.

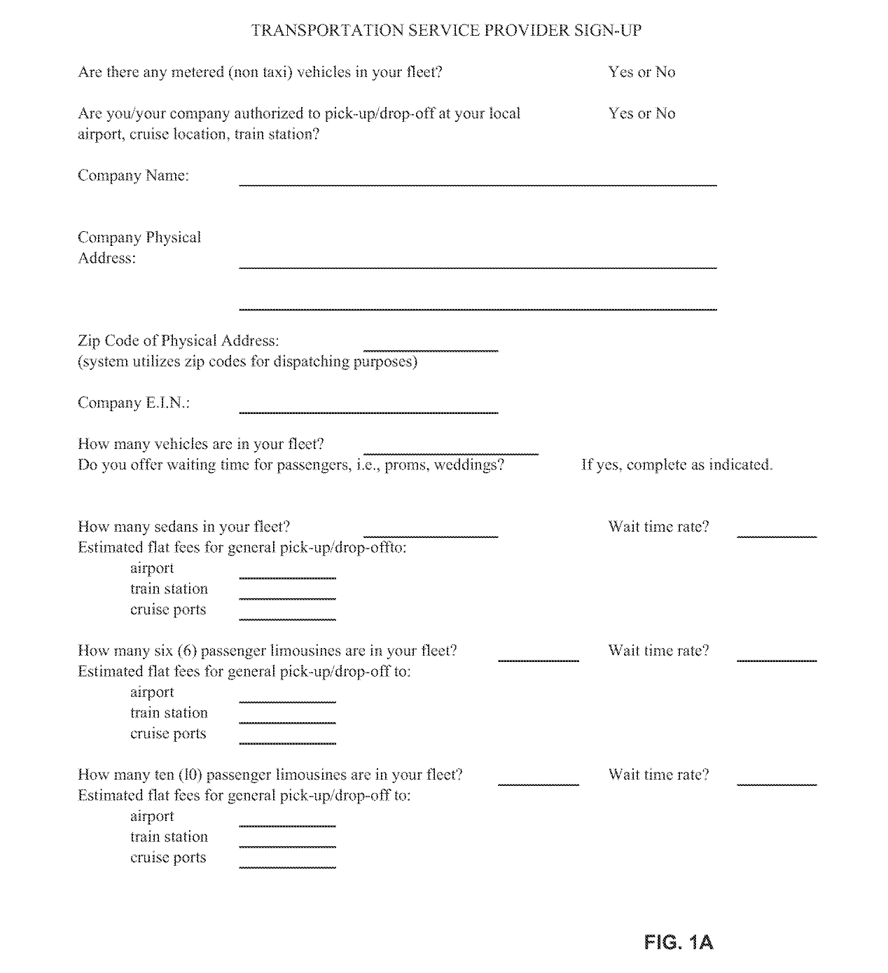

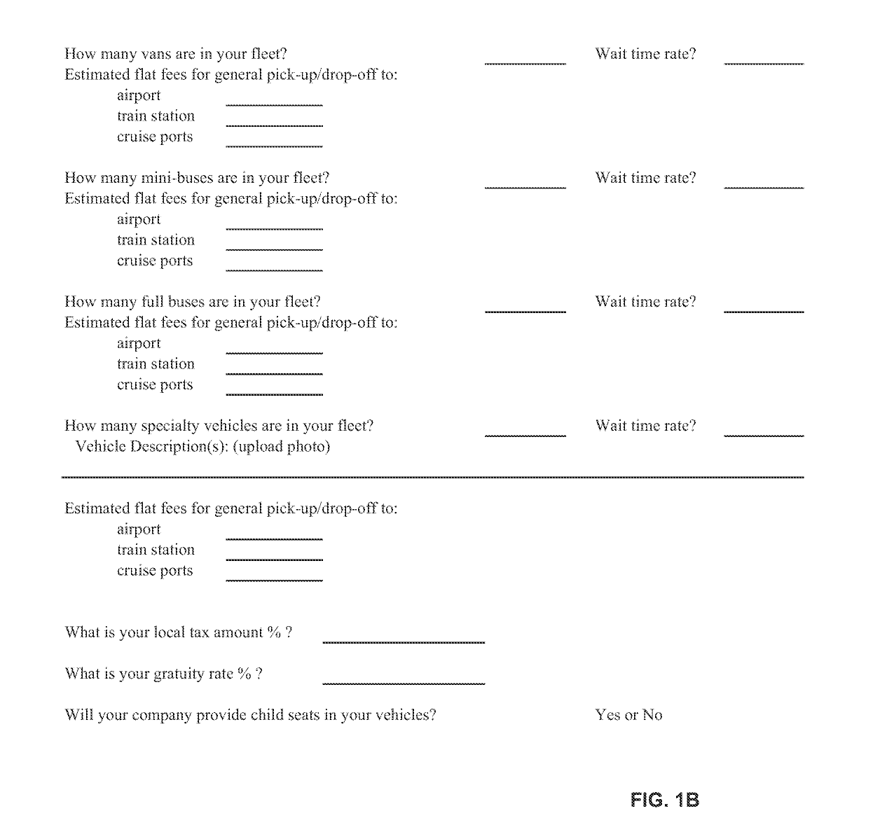

FIGS. 1A and 1B show a copy of a transportation service provider sign up form;

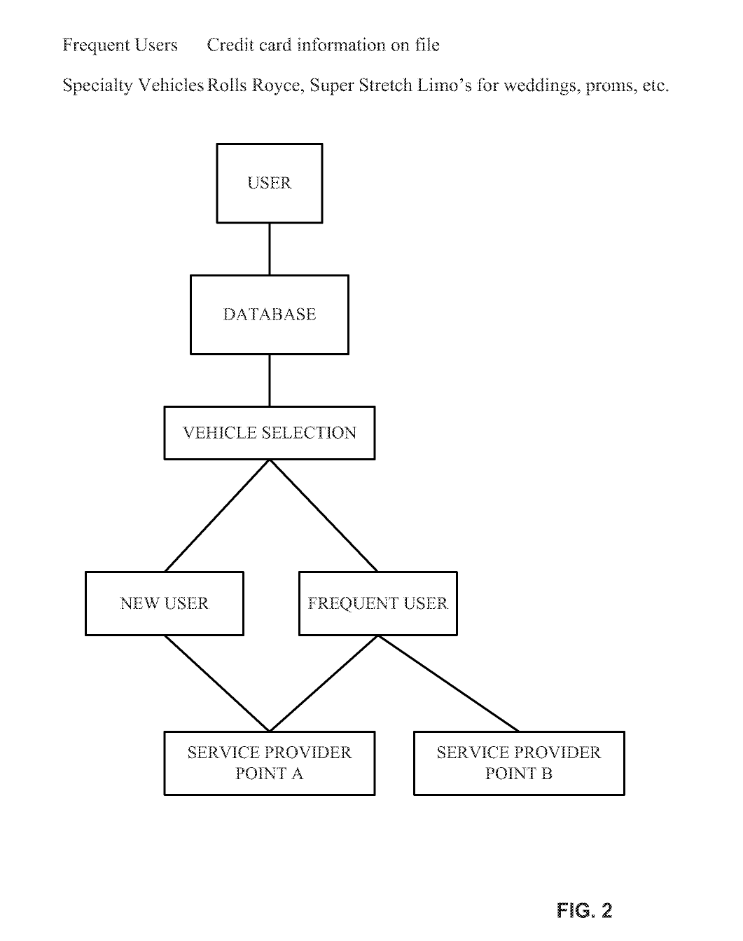

FIG. 2 is a flow diagram of a user direct sign up form;

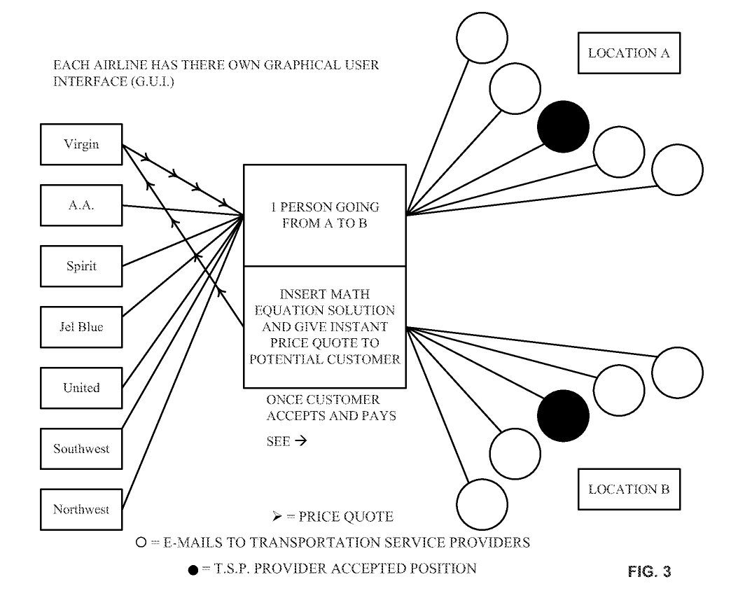

FIG. 3 is a diagram of a user second party air sign up process where the second party is Virgin Air;

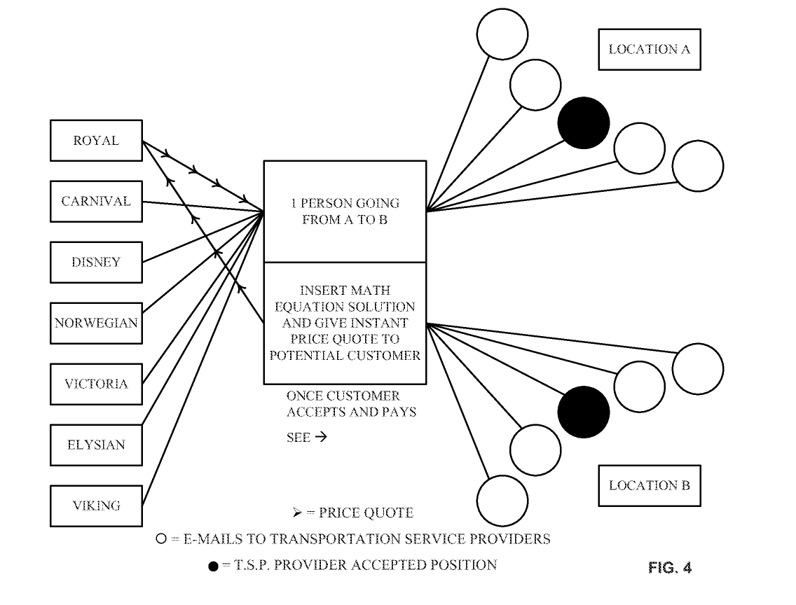

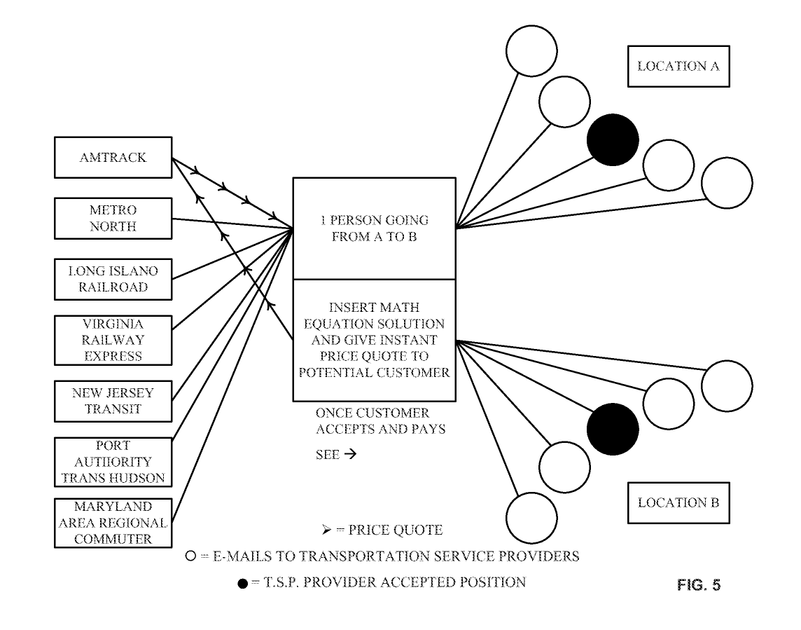

FIG. 4 is a diagram of a user second party cruise ship sign up process where the second party is Royal;

FIG, 5 is a diagram of a user second party train company sign up process where the second party is AMTrack;

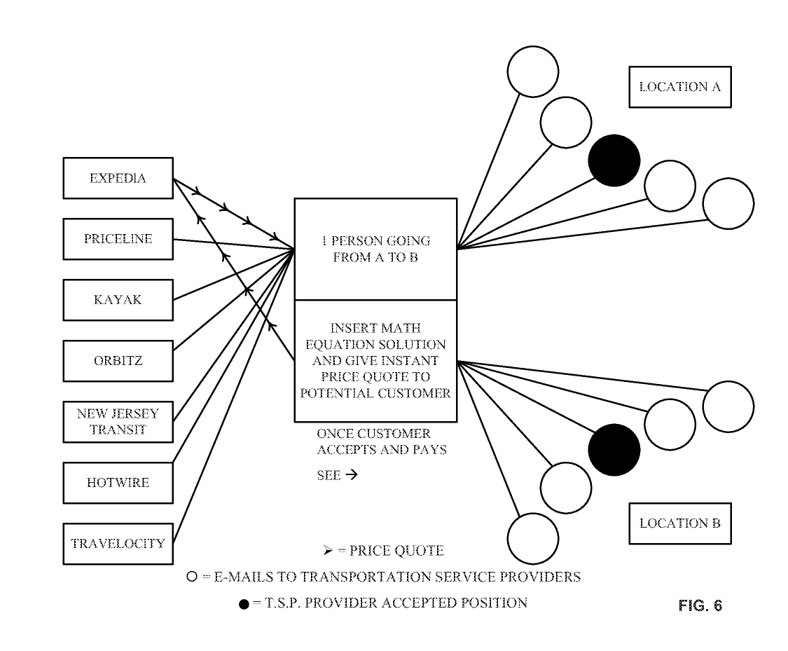

FIG. 6 is a diagram of a user third party sign up process where the third party is EXPEDIA; and

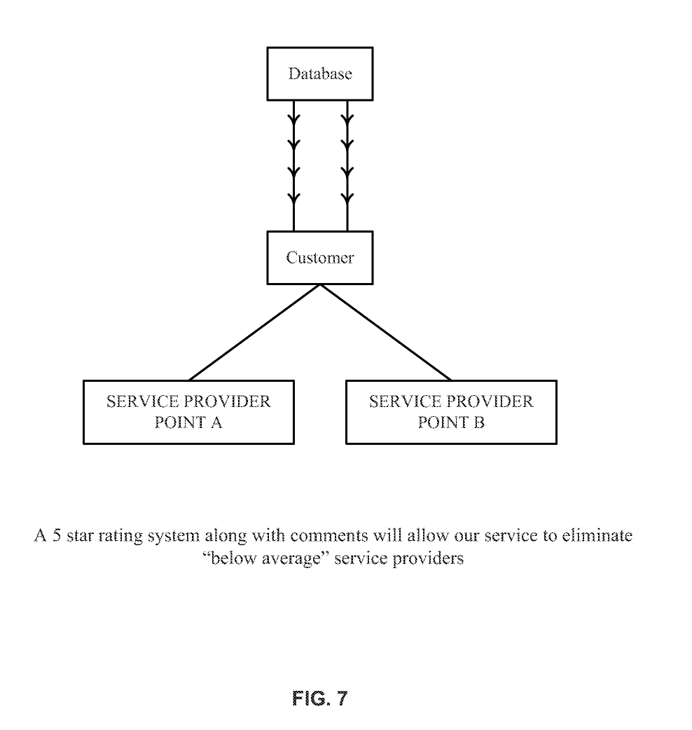

FIG. 7 is a flow diagram of a completion of travel survey form.

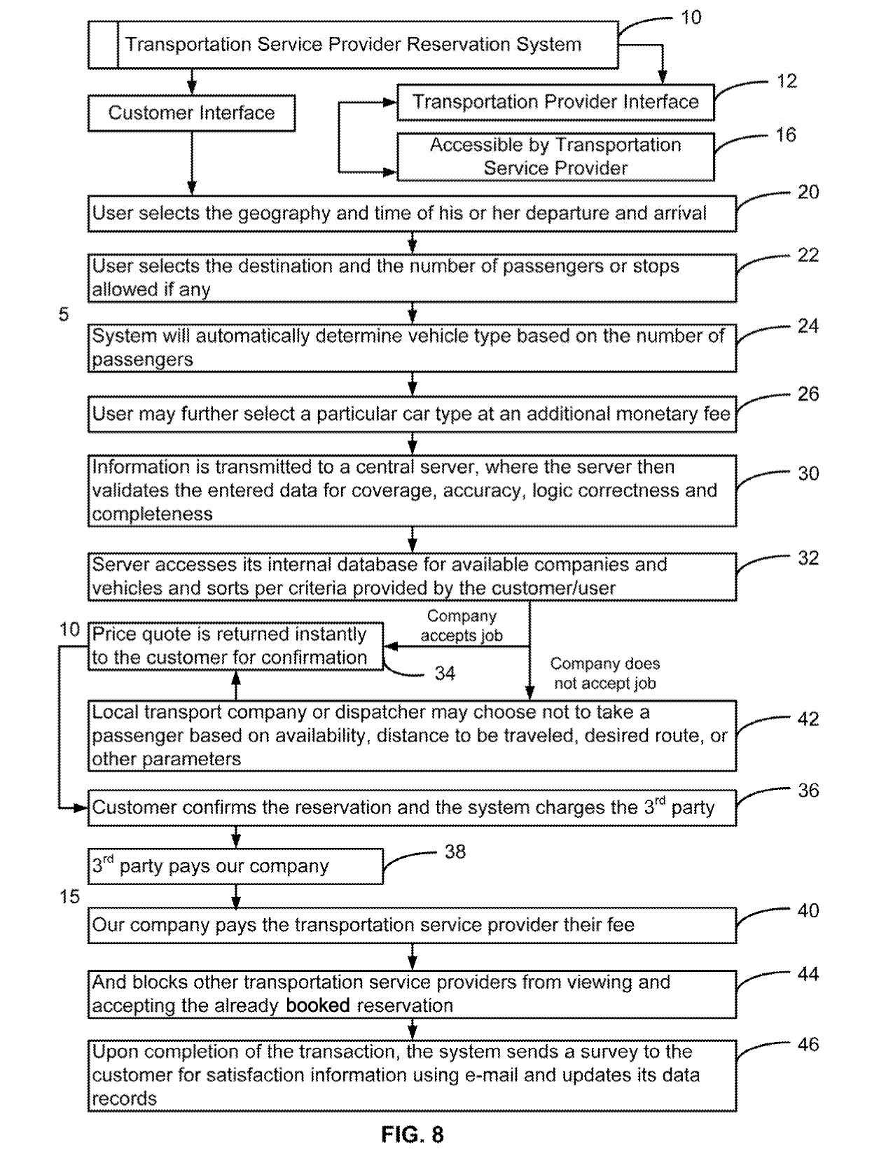

Referring to FIG. 8, there is shown a flow diagram of a method for a transportation service provider reservation system which provides transportation service provider patrons access to a system where each patron can rate the service they receive.

The method shown in FIG. 8 may be performed in real time on a computer having application software installed to cause the computer to operate in accordance with the method The computer system is comprised on a personal computer, The computer has memory to store the software and a processor to execute the method, The computer also has input means typical of a personal computer, such as a keyboard and a mouse.

Continuing with FIG. 8, the Transportation Service Provider Reservation System 10 consists of an application with two interfaces: a transportation provider interface 12 and a customer interface 14. The transportation service provider interface, block 12, is accessible by registered transportation service providers and dispatchers who sign up for our service. The software allows management of car inventory and availability, allowing transportation service provider dispatchers to select arriving and departing passengers in a non-bid format. The system will interface with limo companies so all such functions can be performed automatically based on real time matching to optimize fleet utilization.

The customer interface 14 is accessible by any airline user or wholesale reservation network equipped with the interface protocol which is accessible via computer, smart phone, or any wireless internet access device (such as a Palm VII, Blackberry, WAP phone, and the like), which allows potential customers to schedule, view pricing and book available transportation services and to rate driver service.

Customers can access the reservation system using a computer or wireless device or third party linked software i.e., ever changing GUI to accommodate/match various transportation websites, i.e., American Airlines, Delta, United, etc for non-metered transportation service providers (no taxi's). Next, the user selects the geography and time of his or her departure and arrival, and indicates his or her time of pickup, block 20. The user selects the destination and the number of passengers or stops allowed if any, block 22. The system will automatically determine vehicle type based on the number of passengers, i.e., 1 to 2 passengers default to a standard sedan, three or more passengers will automatically eliminate standard sedans, block 24. The user may further select a particular car type at an additional monetary fee, any special requirements and/or may request an upgrade, block 26.

This information is transmitted to a central server, where the server then validates the entered data for coverage, accuracy, logic correctness and completeness, block 30. The server accesses its internal database for available companies and vehicles and sorts per criteria provided by the customer/user, block 32. The price quote is returned instantly to the customer for confirmation, block 34. If acceptable by the customer, the customer confirms the reservation and the system charges the 3rd. party, block 36. Then the 3rd party pays our company, block 38, and then our company pays the transportation service provider their fee, block 40. However, the local transport company or dispatcher may choose not to take a passenger based availability, distance to be traveled, desired route, or other parameters, block 42. In such a situation, the system would automatically seek out other transportation service provider companies and contacted in a like manner.

The system then matches such request and notifies all involved parties (transportation service provider driver and the customer) and blocks other transportation service providers from viewing and accepting the already booked reservation, block 44. In one embodiment, the system may also track an airline (where, for example, the user is being picked up from an airport) by accessing the flight database or sending confirmation SMS or e-mail messages to the drivers to reschedule the pick up time.

Upon completion of the transaction, the system sends a survey to the customer for satisfaction information using e-mail and updates its data records, block 46.

The system will have a database for the central controller. The database may comprise a car information database and dispatchers, customer information database, and a database comprising information from other networks, i.e., American Airlines, Delta, Orbitz, Travelocity, etc. The car information database will store information on the location of vehicle, type of vehicle, number of vehicles, availability of vehicle, typical cost of a travel and customer rating. The user/customer information database may store information on the location of a user, desired destinations, desired times of pickup at locations, desired time of drop-off at destination, payment information, and number of riders. All of this information would be updated frequently since most of this information is constantly changing. The system utilizes text messaging through each ground transportation company to notify drivers of any delayed of flights or ship departure/arrival information. Provided that the dispatcher assigns a specific job to a specific driver and inputs his mobile device phone number. By doing so, this will eliminate the ground transportation companies resources i.e., drivers, not to waft for delayed flights thus increasing their profitability.

It is to be understood that the invention is not limited to the locality where the server resides. The car information database may contain data related to hundreds of cities. According to the system parameters, it is to operate and provide transportation services in remote locations and urban settings.

It is further understood that the system will only permit transportation service providers who are authorized and licensed to pickup and/or drop off customers should the location need require such.

The website sorts user data by requesting the necessary parameters, such as cost, timing, car size and type of vehicle sought to accommodate the legally correct number of passengers as well as required local law regarding child seats. The system will display the sorted data to the dispatchers. The system receives the user selection, which is based on the sorted data that was displayed to the user/customer.

The website and dispatcher communicates user data to the driver. The dispatcher/transportation service provider accepts incoming jobs via e-mail and provides services at the requested date, time, pick-up location, to be completed by the customer's request when booking their airline/cruise trip.

At completion when the customer arrives at his/her destination, the system will e-mail the customer to rate the quality of service.

In summary, the system and apparatus provides digital travel reservations. The travel reservation system receives travel information from an airline/cruise customer, and validates travel information received. Next, the system accesses its central database to search for available transportation providers in accordance with the received travel information and transmits information regarding available of transportation and price to the customer via the internet. When e-mails are sent to local transportation service providers, and a transportation service provider accepts the job, all other transportation service providers will be locked out from viewing and accepting the reservation in order eliminate double booking of services. The customer receives confirmation regarding the booking and payment of transportation services, and the system transmits reservation information to local transportation service provider via e-mail in conformance with the confirmation received from the customer.

It is to be understood that the term “transportation service provider” by definition for the system is for non-metered vehicles only and has been used herein and in the following claims in the broadest sense possible.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated AH such modifications and variations are within the scope of the invention as determined by the appended claims when interpreted in accordance with the breadth to which they are entitled.

What is claimed is:

1. A computer implemented method for digitally receiving assistance with transportation reservations, comprises:
a. accessing a transportation reservation system via an Internet-enabled device, said transportation reservation system being in digital e-mail communication with a plurality of independent travel service providers;
b. digitally transmitting a travel service request to the transportation reservation system;
c. receiving transportation service information digitally from the transportation reservation system in response to the travel service request;
d. transmitting a digital travel request confirmation to the transportation reservation system; and
e. receiving transportation service in accordance with a digital confirmation.

2. The method of claim 1, further comprises digital transmitting payment information to the transportation reservation system.

3. The method of claim 2, further comprises digitally transmitting identification information to the transportation reservation system, wherein time customer.

4. The method of claim 3, wherein the travel service request comprises at least one of: location information regarding desired transportation, time of desired transportation, or payment method.

5. A computer implemented method of providing travel reservations, comprises:
a. receiving digital travel information from a customer;
b. validating travel information received from the customer;
c. accessing a central storage device to search for available transportation among a plurality of independent travel service providers in accordance with the received digital travel information;
e. receiving confirmation from the transportation service provider dispatchers regarding receiving digital conformation from the available transportation; and
f. digitally transmitting reservation information to a driver who works for the transportation service provider in conformance with the confirmation received from the customer.

6. The method of claim 5, further comprises charging the customer for the service.

7. The method of claim 6 further comprises receiving customer feedback regarding the travel with the transportation service provider and updating its feedback data.

8. The method of claim 7, further comprises transferring payment to the company for the travel.

9. A computer implemented method of providing transportation services by a reservation service provider, comprises:
a. receiving digital notification from a plurality of independent transportation service provider(s) regarding availability for providing transportation;
b. receiving a digital reservation request from a transportation service provider customer;
c. digitally transmitting the reservation request to transportation service provider company;
d. digitally receiving confirmation from the transportation service provider company regarding providing transportation service provider services to the customer in conformance with the reservation request; and
e. locking out all other transportation service providers from viewing and accepting the reservation in order eliminate double booking of services.

10. The method of claim 9, further comprises receiving user feedback regarding the transportation service provider services from the customer after the customer has utilized the transportation service provider services.

11. The method of claim 10, wherein the feedback is incorporated into a rating system for use by transportation service provider dispatcher, wherein the rating system provides rating on a plurality of transportation service provider drivers capable of providing transportation services.
